(19) United States
(12) Patent Application Publication
(10) Pub. No.: US 2023/0191334 A1
(43) Pub. Date: Jun. 22, 2023

(54) Membrane separating method and membrane module for processing liquids

(71) Applicant: Technische Universität Dresden, Dresden (DE)

(72) Inventor: Bertram Skibinski, Markkleeberg (DE)

(21) Appl. No.: 17/284,500

(22) PCT Filed: Oct. 16, 2019
(86) PCT No.: PCT/EP2019/078108

§ 371 Date: Aug. 31, 2021

(30) Foreign Application Priority Data
Oct. 16, 2018 (DE) 10 2018 217 696.5

(51) Int. Cl. B01D 65/08; B01D 63/10; B01D 63/08; C02F 1/32; C02F 1/44; B01D 65/02

(52) U.S. Cl. CPC B01D 65/08; B01D 63/10; B01D 63/08; C02F 1/325; C02F 1/44; B01D 65/022; B01D 2311/2619; B01D 2311/2692; B01D 2313/143; B01D 2313/90; B01D 2315/08; B01D 2315/10; B01D 2321/343; C02F 2303/20; C02F 2303/04; C02F 2201/3225; C02F 2201/3228

(57) ABSTRACT

A membrane module and a membrane separating method for processing liquids, that includes: the liquid stream of a liquid to be processed is supplied, via an inlet, to a separating membrane designed as a flat membrane, such that a purified permeate passes the separating membrane; and the separating membrane is irradiated by UV light at least on the side of the separating membrane facing the inlet, the irradiation by UV light occurring by means of a mat and/or a fabric and/or a grating and/or a net, which consists, in full or in part, of optical waveguide fibers which out-couple light laterally, forming an irradiation element.

### PRIORITY

This application is a national stage entry of PCT/EP2019/078108 filed on Oct. 16, 2019 and claims priority to DE 10 2018 217 696.5 filed Oct. 16, 2018, all of which are incorporated by reference herein for all purposes.

### FIELD

The present invention relates to a membrane separation process for treating liquid.

### BACKGROUND

By means of membrane modules 1 (also referred to as membrane device), some components (e.g., particulate, dissolved inorganic or organic water constituents or microorganisms) in the inflow 17 of the membrane module 1 are selectively retained using separation membranes 5 (also simply referred to as membranes hereinafter) and leave the membrane device 1 as concentrate 19. Other components (e.g., water molecules) pass through the membrane 5 as permeate 18 (FIG. 1). The invention is applicable to liquids in general. However, for the sake of simplicity, mention is often made of water. A person skilled in the art will understand that other liquids can also be meant instead of water.

Membrane separation processes (also simply called membrane processes) such as reverse osmosis, nanofiltration and electrodialysis are used for, inter alia, treatment of liquids. Processes for removing salts, dissolved organic water constituents and colloids such as, for example, humic substances are assumed in particular. This includes the following application areas: desalination of seawater or brackish water, treatment of drinking and service water, production of ultrapure water, wastewater treatment or for concentration of liquids in the food industry. In the application areas mentioned, what is striven for is a high retention of certain components with a simultaneously high permeate flux Jw.

Depending on the pore size of the membrane used, membrane processes are differentiated into microfiltration (0.1-10 micrometers), ultrafiltration (0.01-0.1 micrometer), nanofiltration (0.001-0.01 micrometer), and reverse osmosis, forward osmosis and electrodialysis (<0.001 micrometer). Microfiltration membranes are usually used to retain components of a liquid such as, for example, water, i.e., particulate water constituents. Ultrafiltration membranes retain dissolved water constituents of a molecular size of up to 5000 Da. Only a few components (e.g., salts) pass through nanofiltration membranes. Reverse osmosis, forward osmosis and electrodialysis membranes retain virtually all components in water. The invention relates in particular to membranes and membrane processes of the two last-mentioned categories—nanofiltration, and reverse osmosis, forward osmosis and electrodialysis.

In terms of processing, membranes 5 are used in membrane devices 1. The spiral-wound module is the most commonly used membrane device 1 for reverse osmosis, nanofiltration and electrodialysis membranes.

A spiral-wound module 1 is schematically and exemplarily depicted in FIG. 2. The spiral-wound module 1 consists of multiple quadrangular membranes 5, membrane envelopes 5 here, which are wrapped around the slightly extended permeate collecting tube 12. The membrane materials for a reverse, forward or electrodialysis membrane include polyamide (as a composite membrane), cellulose acetate, aqaporins or polytetrafluoroethylene. The wrapped membrane envelopes 5 are in turn surrounded by a shell element 20. To produce the shell element 20, individual fibers, fiber bundles or planar fabrics composed of heat-resistant, alkali-resistant plastic are wrapped (wound) around the outer peripheral surface of the membrane 5 and embedded in epoxy resin.

Two membrane layers, 9 and 11, which are closed on three sides (here, front side 6, upper side 7 and outflow side 8) form a membrane envelope 5. On the open side, the membrane envelope 5 is connected to the perforated or slitted permeate collecting tube 12. The permeate spacer 10 is situated in the membrane envelope between the membrane layers.

Situated between the membrane envelopes 5 are feed spacers 4, which are likewise wrapped around the slightly extended permeate collecting tube 12. A portion of the inflow 17 to be treated (also called feed stream 17), which enters the membrane device 1 on the front side 2, passes through the membrane 5 and subsequently leaves the membrane device 1 as purified permeate 18 in the direction of the permeate collecting tube 12, whereas a second portion of the feed stream 17 is guided past the membrane 5 as cross flow and leaves the membrane device 1 on the outflow side 3 as retentate 19. Compared to the feed stream 17, the partial stream referred to as retentate 19 additionally contains the majority of the components retained by the membrane 5, whereas the permeate 18 does not contain said components or only contains them to a very insignificant extent. The publication US 2007/0068864 describes a spiral-wound element 1 by way of example.

The permeate spacer 10 forms channels through which permeate 18 inside the membrane envelope 5 reaches the permeate collecting tube 12. Feed spacers 4 form channels through which the feed stream 17 is guided across the upper membrane layer 11 and the lower membrane layer 9 of the membrane envelope 5. The feed spacers 4 in particular additionally ensure flow turbulences and consequently a reduction in concentration polarization on the inflow side of the membrane layers and thus an improved mass transfer.

Concentration polarization is the undesired excessive concentration of a component at the membrane surface facing the inflow 17. The excessive concentration is particularly high in the immediate vicinity of the membrane surface and decreases with increasing distance from the membrane surface in the direction of the free solution. This concentration gradient leads to an additional diffusive flux in the direction of the free solution Jo. As a consequence of this, the permeate flux Jw in the direction of the membrane 5 decreases with increasing excessive concentration at the membrane surface. Under these conditions, the performance of the membrane 5 cannot be fully utilized.

By using a thinner feed spacer 4 for example, the flow rate of the inflow 17 in the inflow-retentate channel is increased and the concentration polarization layer becomes thinner. Customary empty-conduit flow rates in the feed-concentrate channel in the x-direction are in the range of 0.05-1 m/s.

FIG. 3 shows the structure of feed spacers 4 that are currently commonly used. So-called mesh spacers have been used to date. Mesh spacers are layers of a plastic lattice or plastic woven fabric (e.g., polypropylene). Linear elements of the mesh spacer 4a, 4b and 4c, 4d, also called fibers, are arranged in such a way that they intersect and form quadrangles. A distinction is generally made here between two forms of quadrangles, square (FIG. 3a) and diamond (FIG. 3b).

The linear elements 4a in FIG. 3a are arranged in such a way that they are in alignment with the flow direction of the inflow 17 (x). Here, a layer of mostly parallel linear elements 4b lies below a second layer of mostly parallel layer of linear elements 4a, which are arranged at an angle to the upper layer (see FIG. 3c). The linear elements 4b are arranged at an angle of 90° in relation to the position of the linear element 4a. In a second version of the mesh spacers (FIG. 3b), a first layer of mostly parallel linear elements 4c lies below a second layer of mostly parallel linear elements 4d, which are arranged at an angle to the upper layer (see FIG. 3c). The linear elements 4c are arranged at an angle of 45° in relation to the flow direction of the inflow (x). The linear elements 4d are arranged at an angle of −45° in relation to the flow direction of the inflow (x). Feed spacers 4 are primarily produced from thermoplastics such as polypropylene or polyethylene in extrusion processes or 3D-printing processes, which is why the upper and lower layers of linear elements are fused together and the mesh fabric thus represents a uniform mesh structure.

Feed spacers 4 usually have a thickness of 0.66 m, 0.71 mm, 0.79 mm and 0.86 mm. Since thick feed spacers 4 occupy much volume in the membrane module 1, less membrane area can consequently be made available in a membrane module 1.

Furthermore, the publications EP 2 143 480 A1 and WO 2004/112 945 disclose feed spacers 4 which have helical spacer elements. The helical spacer elements allow an even more turbulent and uneven flow, thereby preventing concentration polarization to a greater extent compared to conventional feed spacers 4.

During operation, spiral-wound modules 1 are usually placed in a cylindrical pressure tube 21. The pressure tube 21 has connectors for the front-side inflow 24 (FIG. 4) and for the discharge of the permeate 14 and concentrate 13. The dimensions in which spiral-wound modules 1 are commercially available are: 50 mm, 60 mm, 100 mm and 200 mm (orthogonal to the axial direction, y) and 350 mm, 530 mm and 1000 mm (in the axial direction, x).

The pressure tubes 21 are constructed in such a way that they can accommodate an integral number of spiral-wound modules 1, usually four to seven, one after the other. The feed stream 17 is conducted into the pressure tube 21 in the axial direction (x) via the connector for the feed stream 24 through the front plate 25. A permeate port adapter 22 connects the front plate 25 and the permeate tube 21 of the first spiral-wound module 1. At the same time, it closes the permeate tube 21 on the front side 2. Each of the series-connected spiral-wound modules 1 has two anti-spacing devices 15, which are connected to the shell element 20 and the permeate collecting tube 12 on the front side 2 and on the outflow side 3. The anti-spacing device 15 prevents the displacement of the spirally wound membrane layers 5 and feed spacers 4, for example when hydraulic pressure is applied to the spiral-wound module 1. In one embodiment of the anti-spacing device 15, a seal seals the space between an outer shell element 20 and the pressure tube 21 and thus prevents the feed stream 17 from penetrating into this intermediate zone. The permeate collecting tubes 12 of spiral-wound modules 1 arranged one after the other are connected to one another by an interconnector 23. A pressure tube 21 comprising multiple series-connected spiral-wound modules 1 gives rise to a large membrane element 1. Each pressure tube 21 can in turn be combined with further pressure tubes 21 in series or in parallel, thereby yielding entire filtration systems. Filtration systems can optionally be operated with recirculation of the concentrate or in “single-pass” mode.

Membrane processes such as reverse osmosis, nanofiltration and electrodialysis are distinguished by the application of hydraulic pressure on one side of the semipermeable membrane layer. The pressure causes a fluid to pass through the membrane layer, with components being selectively retained on the membrane layer.

The permeate flux (Jw) in the direction of a membrane 5 is defined as the volume flow rate of permeate 18 (generally in m³ per h) that is normalized to a membrane area (generally 1 m²) and that passes through the membrane 5. For liquids, the permeate flux is proportional to the transmembrane pressure difference (Δp) between the inflow 17 and the permeate 18 (see Marcel Mulder, “Basic Principles of Membrane Technology”, 2nd edition, Kluwer Academic Publishers, Dordrecht, The Netherlands, 1996) and can be determined as follows:

Jw=A(Δp−Δx)

Here, A is the permeability coefficient of the membrane 5 for a liquid and Δx is the osmotic pressure between inflow 17 and permeate 18 at the membrane surface. To overcome the natural process of osmosis, the transmembrane pressure difference must be greater than the prevailing osmotic pressure.

Owing to the excessive concentration and the accumulation, at the membrane surface or in the immediate vicinity thereof, of the components that are present in the inflow 17 and are less permeable, what occurs is the formation of deposits on the membrane 5 and the feed spacer 4. This process is referred to as fouling. A distinction can be made between the following types of fouling: organic fouling, colloidal fouling, scaling and biofouling. Biofouling refers to the accumulation of microorganisms such as, for example, microalgae, fungi, protozoa or bacteria, associated with the formation of a biofilm on the membrane layers and other components of a membrane module 1, such as the feed spacer 4 for example. The position of the biofilm 26 in a spiral-wound module 1 is schematically illustrated in FIG. 5. What is depicted is a section from a spiral-wound module 1 according to FIG. 2 with a feed stream 17, a permeate stream 18 passing through the lower membrane layer 9 and the upper membrane layer 11, and a concentrate stream 19 guided past the membrane layers 9 and 11. A feed spacer 4 is arranged between the membrane layers 9 and 11. This forms channels for the water to be purified, so that it can reach the membrane 5. The biofilm 26 forms on the side on the membrane 5 that is facing the feed stream 17 and on the outer surfaces of the individual fibers of the feed spacer 4.

Biofouling leads to a number of effects that adversely affect the performance of membrane systems.

Biofouling increases concentration polarization and leads to an additional, undesired reduction in the permeate flux Jw in the direction of the membrane 5.

Furthermore, the biofilm formed represents a diffusion barrier for permeable components (e.g., water molecules) before they can pass through the membrane 5. Owing to the formation of the biofilm 26 on the membrane, the effective permeability coefficient of the membrane A decreases, which leads to an undesired reduction in the permeate flux in the direction of the membrane Jw.

Furthermore, the biofilm 26 results in narrowing of the flow cross-section in the inflow-retentate channel. This results in an increased pressure loss along the inflow-retentate channel, since in most modes of operation of a spiral-wound module 1, the same amount of water is still guided past the separation membrane 5 in cross flow and leaves the membrane module 1 as retentate.

Lastly, biofouling also results in a reduced quality of the permeate, since, firstly, the biofilm 26 supports the accumulation of retained components in the immediate vicinity of the membrane surface (e.g., salt retention in the case of the treatment of seawater) and thereby worsens substance retention and, secondly, the biofilm 26 attacks the polymers of the separation membrane 5 through the microorganisms present therein and thereby worsens the retention of undesired substances/components. Such irreversible damage ultimately inevitably leads to the membranes 5 being exchanged.

The effects described above can be reduced by various known measures. For example, these are the removal of the biofilm by flushing the membrane module 1 (by means of chemicals or with use of water or air to generate shear forces), the pretreatment of the inflow before it is conducted into the membrane module (e.g., to kill/inactivate/remove microorganisms in/from the inflow stream or to remove organic substances serving as nutrient for the microorganisms that establish the biofilm) or the alteration of the properties of the separation membrane or the feed spacer (e.g., by means of hydrophilic, bactericidal and/or biocidal modifications/coatings).

The disadvantage of the measures mentioned is that the known measures counteract biofouling only to a certain extent, and so it is necessary to carry out the described pretreatment measures continuously and the described flushing measures regularly (when the membrane separation process is interrupted). Altering membrane or feed-spacer properties can, too, only reduce biofouling, but cannot prevent it. Furthermore, the measures mentioned are, firstly, very complex in terms of processing and, secondly, lead to increased operating and investment costs.

Various measures have been taken to date to kill/inactivate microorganisms in the inflow stream in order to avoid or reduce the effects caused by biofouling. Most commonly by far, biocides or biostatics intended to act on microorganisms by killing them or inhibiting their growth are added to the liquid to be treated. However, such additions are often only effective in high concentrations, can often remove pre-existing deposits only insufficiently or not at all and can even have a damaging effect on the membrane and the performance thereof.

Bactericidally acting UV irradiation is also additionally used to kill/inactivate microorganisms in the inflow stream. UV radiation can be divided into three wavelength ranges: approx. 200 nm to 280 nm (UV-C), approx. 280 nm to 315 nm (UV-B) and approx. 315 nm to 400 nm (UV-A). UV-C radiation in particular acts bactericidally through direct, photochemical DNA damage. This largely occurs through the UV-induced formation of nucleotide dimers in the DNA molecules. The formation of reactive oxygen species due to irradiation in the UV-A and UV-B wavelength range can likewise lead to oxidative damage to microorganisms.

However, UV radiation has the highest bactericidal effect in the wavelength range from 250 to 260 nm. In this wavelength range, DNA absorbs most of the light, which leads to particularly high photochemical DNA damage. A UV dose of approx. 200 to 340 joules per m² is necessary in order to achieve 99% inactivation of the majority of pathogenic germs. Under real conditions, the efficacy of UV radiation depends on many parameters, such as the UV-radiation wavelength used, the species of the bacterium and the composition of the water matrix. UV radiation in the wavelength range of <200 nm (vacuum UV) is predominantly not used for water disinfection because of the formation of unwanted by-products, such as nitrite for example.

The publication US 2004/0232846 describes a typical UV reactor used for water treatment. What are usually used as the UV source are low-pressure mercury lamps or amalgam lamps, which are not directly in contact with the medium to be treated, but are instead encased in a transparent tube usually composed of quartz glass. The UV reactors described can only be used as a pretreatment measure for a spiral-wound module. The disadvantage of using UV reactors is that biofouling can only be counteracted to a certain extent. The growth of a biofilm directly on the membrane layers in the membrane module is not possible via an upstream UV reactor. Consequently, flushing measures for the spiral-wound module must be carried out regularly (when the membrane separation process is interrupted).

The publication U.S. Pat. No. 5,862,449 A discloses a spatial combination of membrane module and UV irradiation. The membrane module, which contains inorganic hollow-fiber membranes (microfiltration) and is placed in water-bearing ground, is used for photocatalytic in-situ treatment of groundwater. The feed stream is conducted into the interior of the hollow-fiber membrane (diameter 0.8-1.9 cm) and then filtered outwardly through the membrane forming the fiber wall. UV-A light (wavelength 350-380 nm) is guided via an optical fiber into the interior of the capillary, where it is laterally coupled out in order to irradiate the membrane. The membrane is impregnated with a UV-A-active layer. The UV-A irradiation of the UV-A-active material leads to the formation of chemically active sites at which unwanted water ingredients are broken down upon passage through the filter.

The publication EP 2 409 954 A1 discloses a spatial combination of membrane module and UV irradiation for water treatment. The membrane module consists of capillary membranes which are irradiated with UV light from the outside or inside by glass fibers laterally radiating UV light. The membrane as well as the glass fibers can be impregnated with a UV-active layer. The UV irradiation of the UV-active material leads to the formation of chemically active sites at which unwanted water ingredients are broken down upon passage through the filter.

The publications DE 69 729 513 T2 and U.S. Pat. No. 6,764,655 B1 disclose spatial combinations of filters and UV irradiation. The filter is formed from fibers, fiber bundles or fiber fabrics that radiate UV light. The pores of the filter are formed by the spaces between the fibers. UV-active substances are immobilized on the fibers. The irradiation of the UV-active material by means of UV light leads to the formation of chemically active sites at which unwanted water ingredients are broken down upon passage through the filter.

The disadvantage of the membrane and filter devices mentioned is that the pore size of the membranes or filters used is too large to be used for reverse-osmosis applications, as described above. Furthermore, the described designs of the membrane and filter devices differ fundamentally from those of a spiral-wound module and can in no way be transferred to the application example of a spiral-wound module. In addition, the UV light used in the membrane and filter devices mentioned is primarily used to form active sites at the UV-active substances. What is usually used for this purpose is light having wavelengths in the UV-A range (350-380 nm), which only contributes to a limited extent to the photochemical inactivation/killing of microorganisms.

### SUMMARY

It is an object of the invention to provide a membrane separation process and a membrane module which does not have the disadvantages of the prior art and significantly reduces the occurrence of biofouling.

This object is achieved by a membrane process and a membrane module according to the independent claims.

The membrane process according to the invention and the device according to the invention both have the advantage over the prior art that direct irradiation of the surface of the separation membrane with UV light effectively prevents biofouling on the membrane side facing the feed stream and thus directly at the site of formation, i.e., directly at the membrane and other membrane module components. The membrane separation process is preferably a process for treating water.

In a preferred embodiment of the present invention, the liquid stream is fed to a membrane module based on spiral-winding technology, wherein a first partial stream passes through the separation membrane as purified permeate and leaves the membrane module, and that a second partial stream is guided past the separation membrane and leaves the membrane module as unpurified retentate comprising an additional portion of the components retained by the separation membrane.

In a preferred embodiment of the present invention, the separation membrane and the irradiation element are part of a membrane module, wherein a first partial stream passes through the separation membrane as purified permeate and leaves the membrane module, and that a second partial stream is guided past the separation membrane and leaves the membrane module as unpurified retentate comprising an additional portion of the components retained by the separation membrane.

In a further preferred embodiment of the present invention, the UV light irradiation is effected by means of an irradiation element which is integrated into the membrane module and especially performs the function of a feed spacer. The inflow is preferably fed to a membrane module based on spiral-winding technology. The irradiation element comprises a UV light source, a light in-coupling element, a light guiding element and a light out-coupling element. Here, the UV light generated in the UV light source is transferred into a light guiding element via a light in-coupling element and then guided toward the light out-coupling element, where it is then coupled out.

The light out-coupling element is preferably additionally impregnated with or surrounded by UV-active substances (e.g., titanium dioxide), which additionally contribute to killing of the biofilm by irradiation with UV light.

In a further preferred embodiment of the present invention, the liquid stream is fed to a membrane designed as a planar membrane and dead-end filtration is carried out for liquid treatment.

In a further preferred embodiment of the present invention, a part of the irradiation element that couples out UV light is positioned in the immediate vicinity of the separation membrane or rests thereon.

According to the invention, the irradiation with UV light is effected by means of a woven fabric and/or a noncrimp fabric and/or a lattice and/or a mesh that completely or partially consists of irradiation element formed optical fibers which laterally couple out light.

The irradiation elements preferably comprise light out-coupling elements.

In a further preferred embodiment of the present invention, what is provided is with light of a wavelength in the UV-A, UV-B and UV-C range. Preference is to be given to using wavelengths in the UV-C range because of the very high biocidal action. In the case of use of titanium dioxide, preference is to be given to using light of a wavelength in the UV-A range (approx. 365 nm). Wavelengths in the visible light range are to be avoided in order to avoid additional biofilm growth induced by visible light.

Preferably, the separation membrane has the irradiation element at least on the side across which the liquid to be treated is supplied thereto.

In a further preferred embodiment of the present invention, the irradiation element of the membrane has a conduit into a pressure tube of the membrane module and optionally a conduit into the interior of the membrane module.

In a further preferred embodiment of the present invention, the irradiation of the membrane via the irradiation element is effected in an intermittent, pulsed or continuous manner.

In a further preferred embodiment of the present invention, the irradiation is effected with constant irradiance and or the irradiation is effected with varying irradiance and.

In a further preferred embodiment of the present invention, the membrane separation process is a membrane separation process suitable for treating drinking water, municipal wastewater, pretreated municipal wastewater, industrial waters and/or saline waters.

In a further preferred embodiment of the present invention, the membrane separation process is a membrane separation process a microfiltration process, ultrafiltration process, nanofiltration process, forward osmosis process, reverse osmosis process, membrane distillation process or electrode ionization process.

In a further preferred embodiment of the present invention, part of the irradiation element is formed as a woven fabric composed of UV-light-radiating optical fibers or UV-light-radiating optical fibers and non-UV-light-radiating plastic fibers.

The membrane module preferably comprises an inflow channel, a separation membrane and an irradiation element. The separation membrane is preferably arranged in the inflow channel. The feed stream is preferably guided across the separation membrane.

In a further preferred embodiment of the present invention, the membrane module comprises a coupling device for connection of a light source. Preferably, the irradiation element comprises the coupling device.

In a further preferred embodiment of the present invention, the irradiation element comprises a light guiding element for low-loss transmission of UV light through a conduit into the membrane module.

In a further preferred embodiment of the present invention, the irradiation element is designed in such a way that reflection is effected for lateral out-coupling of the light radiation.

In a further preferred embodiment of the present invention, the light out-coupling element is designed in such a way that reflection is effected for lateral out-coupling of the light radiation.

In a further preferred embodiment of the present invention, the membrane module is designed as a spiral-wound module.

In a further preferred embodiment of the present invention, the irradiation element is designed as part of a feed spacer or as a feed spacer.

In the case of the particularly preferred embodiment of the invention in which the membrane module is designed as a spiral-wound module having a feed spacer designed as a light out-coupling element or in the case of a membrane process in which a corresponding spiral-wound module is used, the inactivating action of the UV radiation specifically inactivates those microorganisms which adhere on the membrane surface and the feed spacer or which pass through the inflow-retentate channel in cross flow and leave the membrane module as retentate. In the light in-coupling element, the light is preferably guided from the light source into the light guiding element. In one variant of the invention, a punctual light source, for example one or more light-emitting diodes which emit UV light (UV LEDs) that have the same or different emission wavelengths, is used as the light source. For light coupling, a hollow cylinder having high UV reflection on the inner wall (e.g., internally polished cylinder composed of aluminum or PTFE) is preferably placed onto the UV LED. A lens which is directly positioned on the LED and/or is situated in the hollow cylinder can optionally help to focus the radiated light in such a way that the light is coupled into the light guiding element more efficiently.

Individual optical fibers or bundles of optical fibers are preferably positioned on the opposite opening of the cylinder. These serve as a light guiding element.

In a further variant of the invention, further light sources, such as, for example, mercury vapor-pressure lamps, are used. The emitted UV light is preferably bundled via reflectors and one or more lenses, so that it is coupled into individual optical fibers or bundles of optical fibers.

In a preferred embodiment of the invention, the light source is situated outside the membrane module. The light guiding element then guides the UV light from the light source into the membrane module. In one variant of the invention, optical fibers are used as the light guiding element. These can be designed as mono- and multimodal optical fibers and consist of one or more cores and one shell layer. In a preferred variant, one or more protective layers composed of plastic are provided outside the shell, which layers protect the shell from external influences. The optical fibers preferably consist of solarization-resistant materials such as, for example, quartz glass, which exhibit high UV transmission. Alternatively, the material used can also be polymers which exhibit high transmission for light in the UV wavelength range. Optical fibers based on quartz glass comprise a core composed of quartz glass and a doped shell, for example fluorine-doped shell, composed of quartz glass. The quartz glass preferably has a high OH content in order to increase UV transmission. Polymeric optical fibers (POFs) preferably comprise a core composed of polymethyl methacrylate (PMMA) or polydimethylsiloxane (PDMS) and a doped shell, for example fluorine-doped shell, composed of PMMA or PDMS. The in-coupled UV light is guided in the optical waveguide by means of reflection (especially total internal reflection).

In the preferred embodiment of the invention, the spiral-wound module, the optical fibers are guided via a cable conduit into the interior of the pressure tube, where they are guided through the shell element of the spiral-wound module. In this way, the optical fibers are fed to the wrapped membrane envelopes. The production of the shell element preferably involves wrapping not only individual fibers, fiber bundles or planar fabrics composed of heat-resistant, alkali-resistant plastic, but also simultaneously the optical fibers, around the outer peripheral surface of the membrane and embedding them in adhesives such as, for example, epoxy resin.

The light out-coupling element is preferably designed as a mesh and/or woven fabric and/or noncrimp fabric and/or lattice. This preferably partially or completely consists of optical fibers which laterally couple out light.

In a preferred embodiment of the invention, the optical fibers which laterally couple out light are a direct extension of the optical fibers which were used as the light guiding element. In this case, one or more optical fibers which laterally couple out light are connected to an optical fiber which is used for light guidance. Advantageously, in the case of the embodiment of the invention described as a spiral-wound module or with use of a spiral-wound module, the mesh fabric is designed in such a way that it performs the function of a feed spacer. In such a manner, the feed spacer is to be designed as a light out-coupling element and additionally performs the function of a flow homogenization element.

The light out-coupling element is preferably realized by multiple linear elements of a mesh spacer. Linear elements of a mesh spacer can be either completely realized as UV-light-radiating optical fibers or partially realized as UV-light-radiating optical fibers and non-UV-light-radiating plastic fibers (e.g., polypropylene). The light out-coupling element is preferably designed as a web-type woven fabric mat or noncrimp fabric mat composed of individual optical fibers, bundles of optical fibers, and non-UV-light-radiating plastic fibers. Furthermore, conventional mesh spacers composed of non-UV-light-radiating plastic fibers (e.g., polypropylene) can be modified by addition (e.g., insertion or interweaving) of individual UV-light-radiating optical fibers. Here, the feed spacer designed as a light out-coupling element is thus the central component of the membrane module designed as a spiral-wound module, with respect to the prevention of biofouling. This structure of a membrane module allows, for the first time, direct irradiation with UV light of the entire membrane surface or at least of parts of the membrane surface in a membrane module designed as a spiral-wound module for example, thereby effectively counteracting the formation of a biofilm.

If the light out-coupling element has the form of a feed spacer, it has very similar properties to a conventional feed spacer, thereby realizing, firstly, the function of spacing of the separation membrane of the membrane envelopes and hence of construction of a retentate channel and thereby allowing, secondly, the direct irradiation of the surface of the separation membrane with UV light.

It is conceivable that the linear elements are printed by means of a 3D-printing process. The linear elements are preferably printed onto the membrane by means of a 3D-printing process.

Linear elements of the mesh spacer are preferably fixed to one another or to themselves at intersecting sites with the aid of thermal processes (e.g., heat setting, calendering) and/or by means of adhesives (e.g., epoxy resins, polyurethane systems) and/or by adhesive yarns or hot-melt adhesive yarns in order to achieve an increased mesh strength of the woven fabric or noncrimp fabric.

The UV-light-radiating effect of a linear light out-coupling element can, for example, be achieved by partial removal of the shell or removal of protective plastic layers of the shell of an optical fiber (e.g., by etching processes or by mechanical treatment by, for example, compressed-air blasting using solid blasting abrasive, laser-induced damage or targeted cuts). This can be done over a particular region or else punctually at one or more sites of the linear light out-coupling element. Alternatively, scattering particles (e.g., aluminum or polymer particles) can be added to the shell material when producing the optical fiber, which scattering particles serve as scattering sites and thus couple the light out of the core of the optical fibers.

A single optical fiber is particularly preferably connected to a single UV-light-radiating optical fiber. This can be done by connecting the two fibers by, for example, splicing. Optical fibers and UV-light-radiating optical fibers can, however, also be produced from originally one continuous fiber. Splicing is not necessary in this example to connect light guiding element and light out-coupling element to one another. Alternatively, the linear light out-coupling region can be encased with a plastic layer, preferably permeable to UV light, in order to ensure protection of the linear elements of the mesh spacers.

The irradiation of the membrane via the irradiation element can be effected in a continuous manner with constant or varying irradiance, in a pulsed manner with the same or varying irradiance and pulse and pause durations of successive light pulses or in an intermittent manner with the same or varying irradiation duration, irradiation pause and irradiance between two irradiation intervals.

The inactivating action of the UV radiation, which can be emitted by the feed spacer element designed as an irradiation element, selectively inactivates, for the first time, those microorganisms which directly adhere on the membrane, which adhere on the feed spacer element designed as an irradiation element and which pass through the inflow-retentate channel in convective material flow.

In an alternative possible embodiment of the invention, the feed stream is fed to a planar membrane, with performance of so-called dead-end filtration for liquid treatment, in which the inflow stream is pumped against a planar membrane at low pressure (approx. 0.2-1 bar). Owing to the use of UV light irradiation, the buildup of a filter cake (top layer or fouling) that takes place as a result of the constant drainage of the permeate can be reduced considerably.

The above-described and other advantageous embodiments and developments of the invention can be gathered from the dependent claims and the description with reference to the drawings.

Further details, features and advantages of the invention are revealed by the drawings and by the following description of preferred embodiments with reference to the drawings. At the same time, the drawings merely illustrate exemplary embodiments of the invention that do not restrict the essential concept of the invention.

### BRIEF DESCRIPTION OF THE FIGURES

FIG. 1 shows a schematic depiction of a membrane module with its material flows according to the prior art.

FIG. 2 shows the in-principle structure of a spiral-wound module according to the prior art.

FIG. 3 shows feed spacers in diamond and square form according to the prior art.

FIG. 4 shows the arrangement of a spiral-wound module in a pressure tube.

FIG. 5 shows a membrane module according to FIG. 1 containing a corresponding biofilm.

FIG. 6 shows schematic depictions of an irradiation element according to a first exemplary embodiment of the present invention.

FIG. 7 shows a schematic depiction of a membrane module according to a first exemplary embodiment of the present invention.

FIG. 8 shows an in-principle depiction of a membrane module according to the prior art having a planar membrane, with performance of dead-end filtration for liquid treatment.

FIG. 9 shows a membrane module according to an exemplary embodiment of the present invention in an in-principle depiction of a single optical fiber in a tube or capillary membrane.

FIG. 10 shows a membrane module according to an exemplary embodiment of the present invention in an in-principle depiction of a capillary membrane in a capillary module.

FIG. 11 shows schematic depictions of a section through a light out-coupling element according to an exemplary embodiment of the present invention as woven fabric and noncrimp fabric.

### DETAILED DESCRIPTION

In the various figures, the same parts are always provided with the same reference signs.

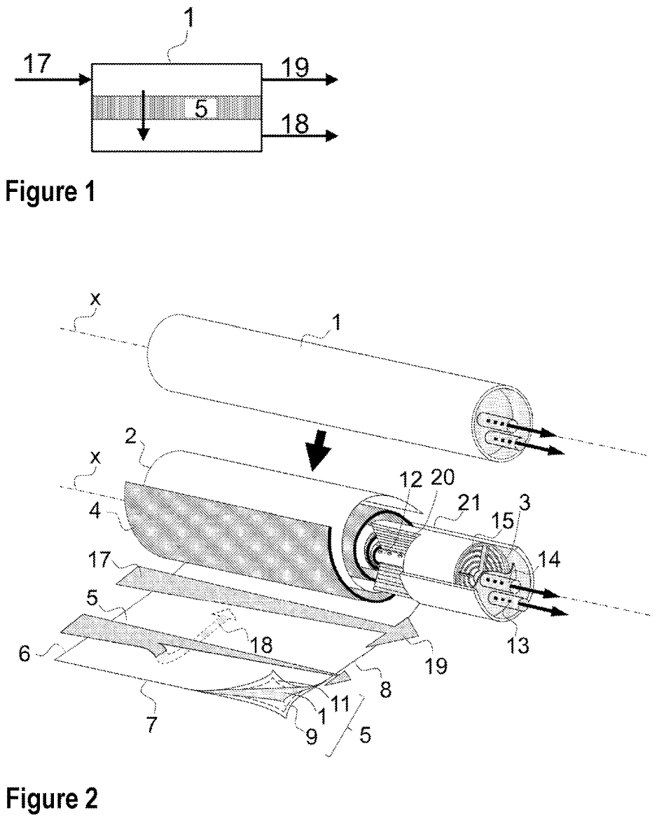

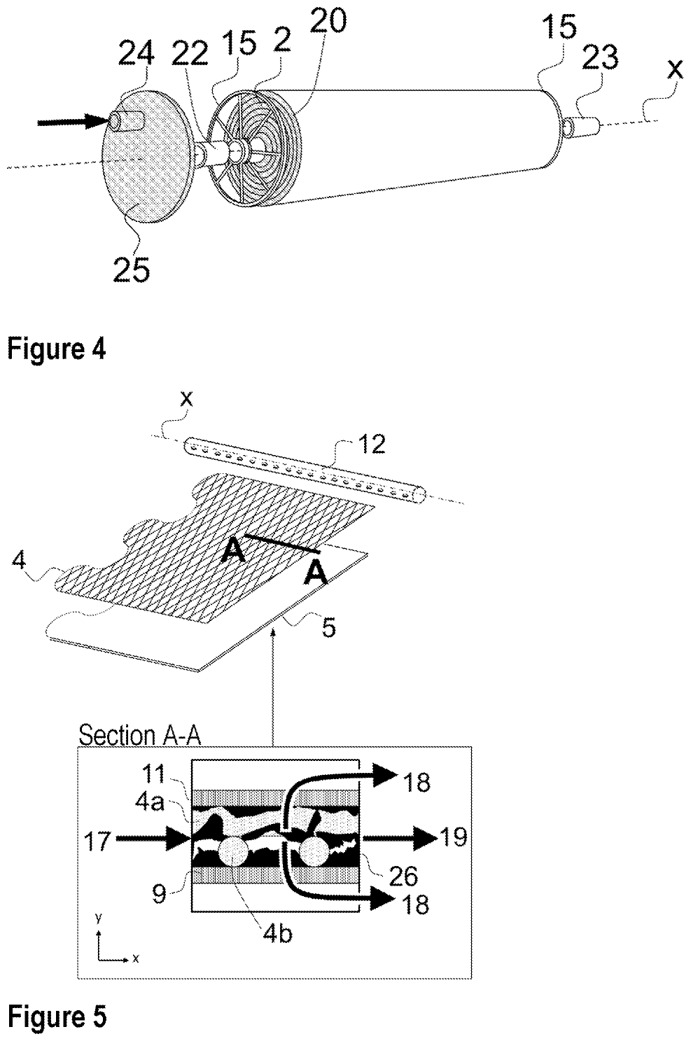

FIGS. 1 to 5 have already been described above.

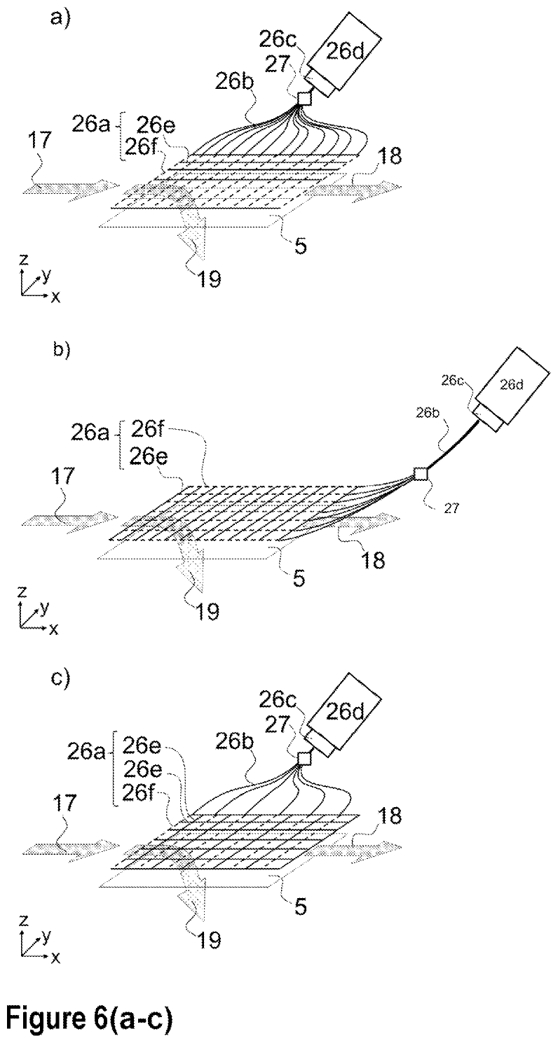

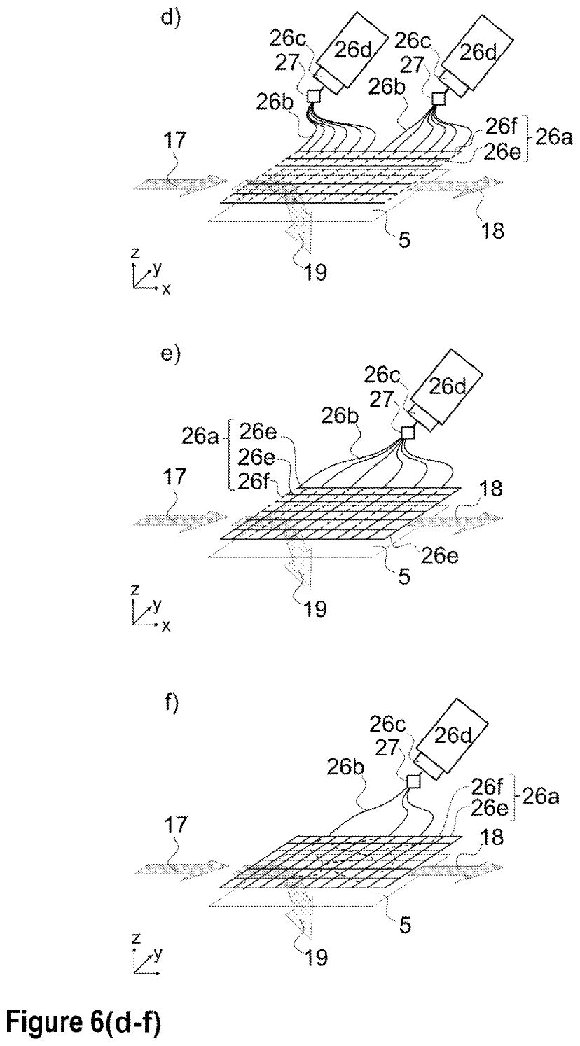

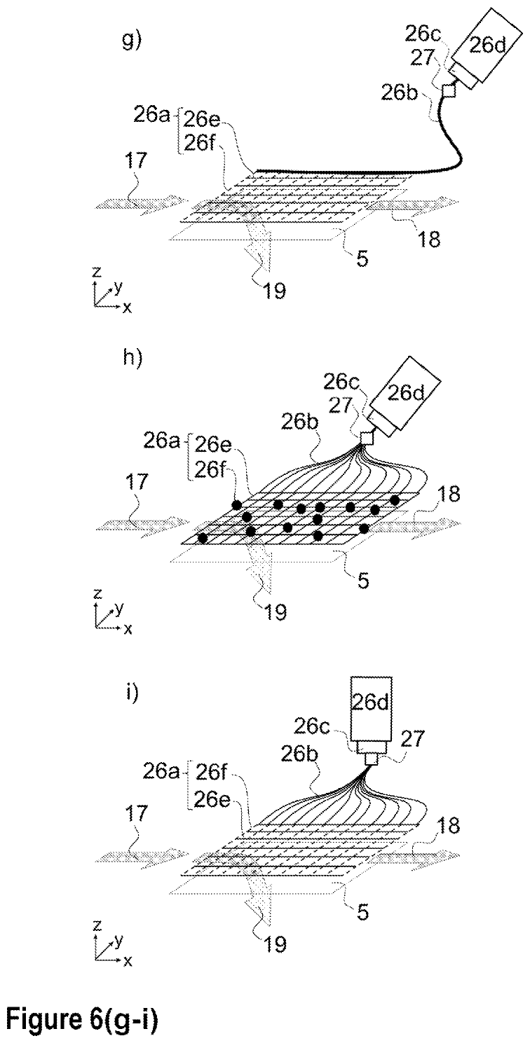

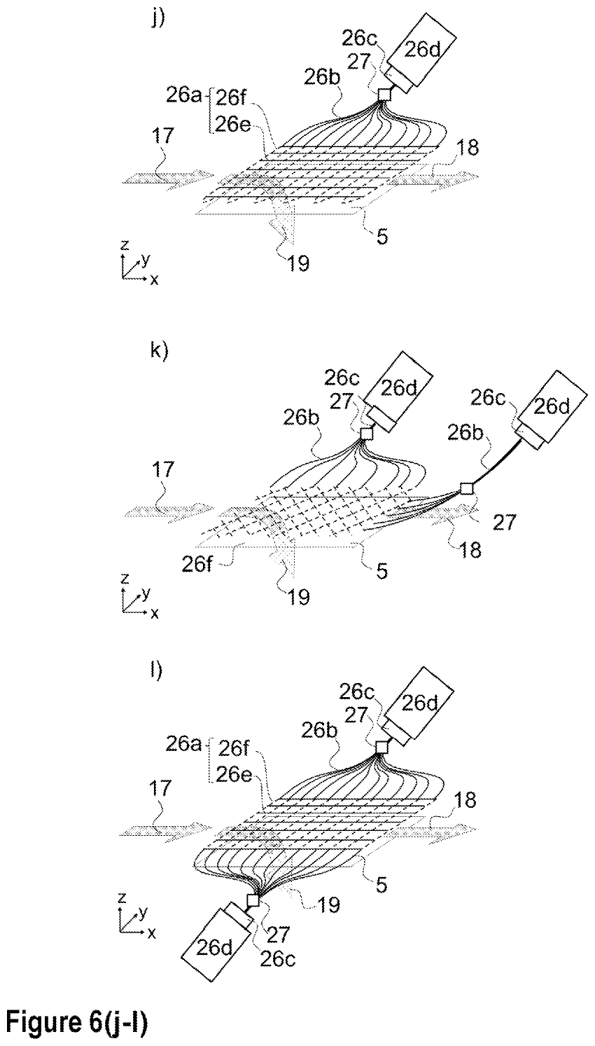

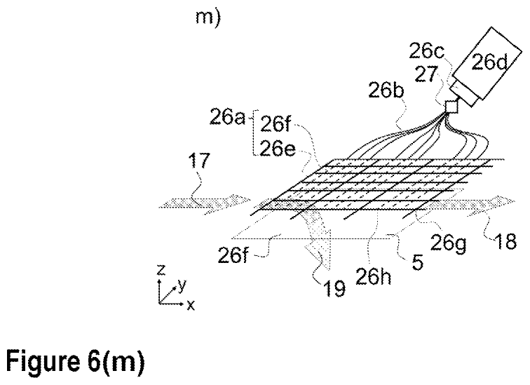

FIG. 6 (a-j) schematically depicts an irradiation element 26 in a preferred embodiment of the invention as a mesh fabric. The irradiation element 26 consists of a UV light source 26d, light in-coupling element 26c, light guiding element 26b and light out-coupling element 26a. When the invention is used in membrane modules 1, the light guiding element 26b is guided into the interior of the membrane module 1 via a conduit 27. FIGS. 6a-6j show various embodiments of the irradiation element 26. An irradiation element 26 can be realized according to one embodiment of the present invention. It is also conceivable to realize the irradiation element 26 according to a combination of the embodiments shown here.

FIG. 6(a) shows an irradiation element 26. The light out-coupling element 26a consists of non-UV-light-radiating linear elements (e.g., polypropylene fibers) 26e which run largely parallel to the flow direction in the feed-concentrate channel (x) and UV-light-radiating linear elements 26f (e.g., multimodal or monomodal glass fibers) which run at an angle (here, 90°) to said flow direction. Each linear element 26f is coupled to a linear light guiding element 26b, which in turn leads into the light in-coupling element 26c.

In an alternative embodiment (FIG. 6(g)), the UV-light-radiating linear elements 26f are connected to a single linear light guiding element 26b. It is likewise guided into the interior of the membrane module 1 through a conduit 27.

In a further alternative embodiment (FIG. 6(i)), the conduit 27 is directly integrated to the light in-coupling element 26c, and so no light guiding element 26b is used between conduit 27 and light in-coupling element 26c.

In a further alternative embodiment (FIG. 6(j)), UV-light-radiating linear elements 26f are designed in such a way that both ends of the element are connected either to the same light guiding element 26b or to different ones (as shown).

FIG. 6b shows an irradiation element 26. The light out-coupling element 26a consists of UV-light-radiating linear elements 26f which run largely parallel to the flow direction in the feed-concentrate channel (x) and non-UV-light-radiating linear elements 26e which run at an angle (here, 90°) to said flow direction.

FIG. 6c shows an irradiation element 26. The light out-coupling element 26a consists of non-UV-light-radiating linear elements 26e which run largely parallel to the flow direction in the feed-concentrate channel (x) and any desired sequence of UV-light-radiating linear elements 26f and non-UV-light-radiating linear elements 26e which run at an angle (here, 90°) to said flow direction.

FIG. 6d shows an irradiation element 26. The light out-coupling element consists of a combination of non-UV-light-radiating linear elements 26e and UV-light-radiating linear elements 26f. By way of example, an arrangement of non-UV-light-radiating linear elements 26e and UV-light-radiating linear elements 26f is chosen here analogously to the embodiment in FIG. 6a. As an alternative to the embodiments from FIGS. 6a-6c, an irradiation element can have one or more light sources, comprising a common light source 26d or multiple light sources 26d and separate light in-coupling elements 26c, light guiding elements and conduits 27 into the interior of the membrane module.

FIG. 6e shows an irradiation element 26. The design of the light out-coupling element 26a is largely analogous to the embodiment in FIG. 6(c). However, in contrast to the embodiment in FIG. 6c, individual UV-light-radiating regions 26f are not realized over the entire length of the irradiation element 26, but only partially over a limited length of the irradiation element 26.

FIG. 6f shows an irradiation element 26. The light out-coupling element 26a is formed with irregularly running linear UV-light-radiating linear elements 26f which are introduced in a lattice, mesh, noncrimp fabric and/or woven fabric composed of non-UV-light-radiating linear elements 26e.

In a preferred embodiment (FIG. 6(m)), the non-UV-light-radiating linear elements 26e are predominantly fixed to one another at intersecting sites 26g (e.g., by thermal processes such as heat setting or calendering and/or by means of adhesives (e.g., epoxy resins, polyurethane systems)) in order to achieve an increased mesh strength of the lattice, mesh, noncrimp fabric or woven fabric. UV-light-radiating linear elements 26f are only fixed at isolated sites 26h, mostly in the outer region of the light out-coupling element 26a, either to non-UV-light-radiating linear elements 26e or UV-light-radiating linear elements 26f (e.g., by thermal processes such as heat setting or calendering and/or by means of adhesives (e.g., epoxy resins, polyurethane systems)).

FIG. 6(h) shows an irradiation element 26. The light out-coupling element 26a is substantially composed of non-UV-light-radiating linear elements 26e which have one or more punctual light out-coupling sites 26a.

FIG. 6(k) shows an irradiation element 26. The light out-coupling element 26a is composed of linear elements 26e and 26f which are arranged at an angle (here, approximately +45° and −45° in relation to the flow direction of the inflow (x). The linear elements are arranged in such a way that they intersect and form a diamond shape.

FIG. 6(l) shows an irradiation element 26. The light out-coupling element 26a is composed of linear elements. The UV-light-radiating linear elements 26e

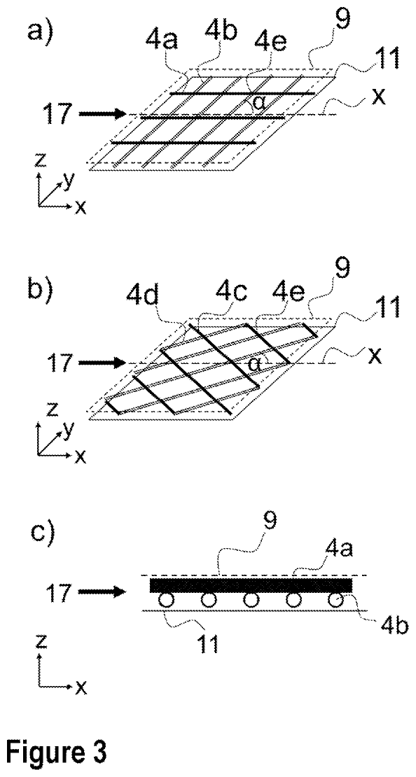

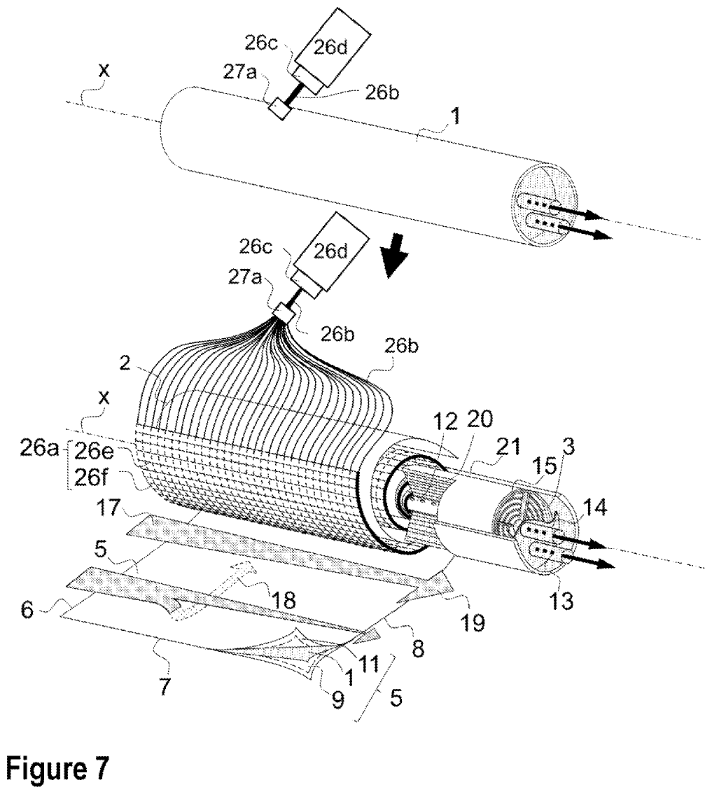

What is realized in FIG. 7 by way of example is the basic structure of the irradiation element 26 in a structure of a spiral-wound module 1 according to an exemplary embodiment of the present invention, analogous to that described in FIG. 3. In contrast to the prior art, what is used instead of a conventional feed spacer 4 in the form of a customary woven fabric mat formed from individual polymer strands is a feed spacer 4, designed as irradiation element 26, in the structure of the spiral-wound module 1. The feed spacer 4 designed as irradiation element 26 is, too, advantageously designed as a woven fabric (mat) having corresponding spacer elements, which in this case are composed of non-UV-light-radiating linear elements 26e and UV-light-radiating linear elements 26f.

The spiral-wound module 1 is formed or constructed from multiple membrane envelopes 5, which are wrapped around a permeate collecting tube 12 with separation by irradiation elements 26 and are enclosed by an outer shell element 20.

The conduit 27a of the light guiding elements 26b is effected in different ways depending on the embodiment of the irradiation element (see FIG. 6 (a-j)).

In the preferred embodiment, the conduit is effected through the shell element 20 and the pressure tube 21 (as depicted in FIG. 7).

In an alternative embodiment, the conduit is effected through the shell element 20 and the front plate 25 or the rear plate (not shown in FIG. 7) of a pressure tube. This embodiment is preferably used when the light guiding and light out-coupling elements of the irradiation element run at an angle (here, 90°) to the flow direction x (see, for example, FIG. 6(a)).

In a further embodiment, the conduit 27a is solely effected either through the pressure tube 21 or the front plate 25 or the rear plate (not shown) of a pressure tube. This third embodiment is preferably used when the light guiding and light out-coupling elements of the irradiation element run in the flow direction x (see, for example, FIG. 6(b)).

A combination of these two embodiments is possible, too. In this case, parts of the light guiding elements 26b are guided outside the pressure tube according to one of the embodiments.

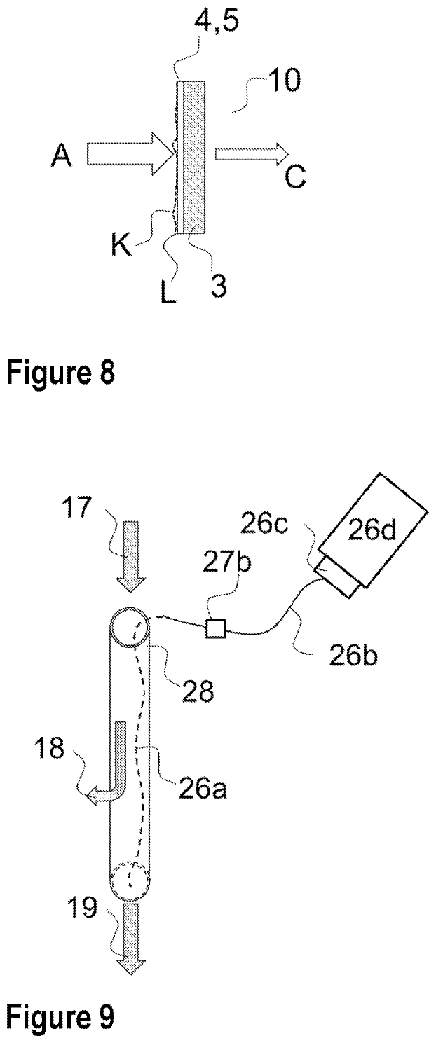

FIG. 8 shows a membrane module 1 according to the prior art having a planar membrane 3, with performance of dead-end filtration for liquid treatment.

FIG. 9 shows a schematic depiction of a membrane module according to an exemplary embodiment of the present invention. What is proposed is a separation membrane 3 which is provided on its inflow side with an irradiation element L, preferably also in the form of a woven fabric mat 5 composed of optical fibers 4 or bundles produced therefrom—or such a woven fabric mat 5 is arranged on this side of the separation membrane 10. As already described in the embodiment relating to the spiral-wound module 1, UV light is supplied via individual optical fibers 4 which are connected to a corresponding UV light source 7 via a coupling module 6. Owing to the arrangement according to the invention of a fiber-optic woven fabric mat 5 on the inflow side on the separation membrane 3, the buildup of a corresponding filter cake K is greatly reduced or considerably delayed, meaning that cleaning and maintenance work or membrane exchange need not be done until considerably later.

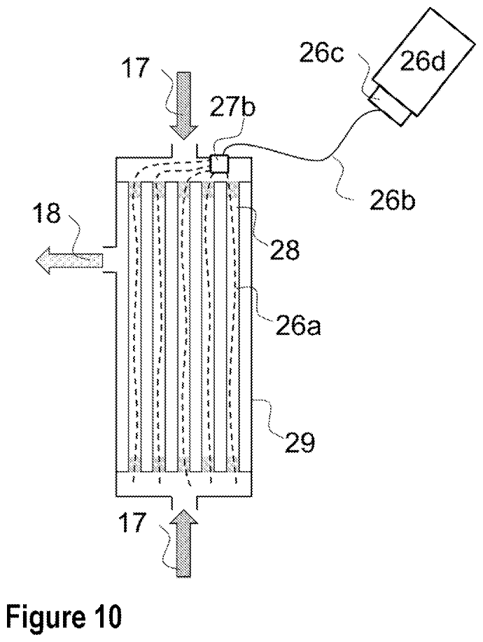

FIG. 10 shows a membrane module according to an exemplary embodiment of the present invention in an in-principle depiction with a capillary membrane in capillary module 29. The light source 26d is connected to the light guiding element 26 via the light in-coupling element 26c, so that UV light can be coupled from the light source 26d into the light guiding element 26b. The light guiding element 26b guides the UV light into the capillary module 29 through the conduit 27 and into the capillary membrane 28 via light out-coupling elements 26a.

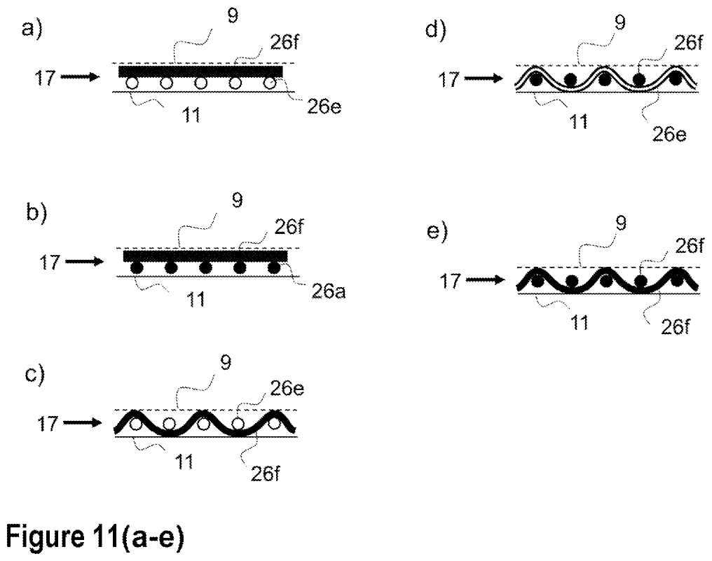

FIG. 11 (a-d) depicts a schematic section through a light out-coupling element in exemplary embodiments as a noncrimp fabric (FIG. 11 (a, b)) and woven fabric (FIG. 11 (c-e)).

FIG. 11a shows a schematic section through a light out-coupling element designed as a noncrimp fabric. Resting on a non-UV-light-radiating linear element 26e is a UV-light-radiating linear element 26f.

FIG. 11b shows a schematic section through a light out-coupling element designed as a noncrimp fabric. Resting on a UV-light-radiating linear element 26a is a UV-light-radiating linear element 26a.

FIG. 11c shows a schematic section through a light out-coupling element designed as a woven fabric. A UV-light-radiating linear element 26f is placed above or below a non-UV-light-radiating linear element 26e.

FIG. 11d shows a schematic section through a light out-coupling element designed as a woven fabric. A non-UV-light-radiating linear element 26e is placed above or below a UV-light-radiating linear element 26f.

FIG. 11e shows a schematic section through a light out-coupling element designed as a woven fabric. A UV-light-radiating linear element 26a is placed above or below a UV-light-radiating linear element 26f.

### LIST OF REFERENCE SIGNS

1 Membrane module (spiral-wound module)
2 Front side of the membrane module
3 Outflow side of the membrane module
4 Feed spacer
4a, 4b, 4c, 4d, 4e Linear elements of the feed spacer
5 Membrane (membrane envelope)
6 Front side of the membrane envelope
7 Upper side of the membrane envelope
8 Outflow side of the membrane envelope
9 Lower membrane layer of the membrane envelope
10 Permeate spacer
11 Upper membrane layer of the membrane envelope
12 Permeate collecting tube
13 Concentrate outflow
14 Permeate outflow
15 Anti-spacing device
17 Inflow
18 Permeate
19 Concentrate
20 Shell element
21 Pressure tube
22 Permeate port adapter
23 Interconnector
24 Pressure tube connector for the feed stream
25 Front plate of the pressure tube
26 Irradiation element
26a Light out-coupling element
26b Light guiding element
26c Light in-coupling element
26d UV light source
26e Non-UV-light-radiating linear elements
26f UV-light-radiating linear elements
26g Fixation of the non-UV-light-radiating linear elements 26e to one another
26h Fixation of the UV-light-radiating linear elements 26f to non-UV-light-radiating linear elements 26e or UV-light-radiating linear elements 26f
27 Conduit of the light guiding elements into a membrane module
27a Conduit of the light guiding elements through the pressure tube of a spiral-wound module
27b Conduit of the light guiding elements through the pressure tube of a capillary module
28 Capillary membrane
29 Capillary module (inside-out operation)
K Filter cake (dead-end filtration)

1. A membrane separation process for treating liquid comprising:
feeding a liquid stream of the liquid to be treated to a separation membrane designed as a planar membrane via an inflow so that a purified permeate passes through the separation membrane,
wherein the separation membrane is irradiated with UV light at least on a side of the separation membrane facing the inflow,
wherein the irradiation with the UV light is effected by means of a noncrimp fabric and/or a woven fabric and/or a lattice and/or a mesh that completely or partially consists of an irradiation element formed optical fibers which laterally couple out light.

2. The membrane separation process as claimed in claim 1, wherein
the separation membrane and the irradiation element are part of a membrane module,
wherein a first partial stream passes through the separation membrane as purified permeate and leaves the membrane module, and a second partial stream is guided past the separation membrane and leaves the membrane module as unpurified retentate comprising an addition portion of the components retained by the separation membrane.

3. The membrane separation process as claimed in claim 2, wherein
the UV light irradiation is effected by means of the irradiation element which is integrated into the membrane module and especially performs a function of a feed spacer.

4. The membrane separation process as claimed in claim 1, wherein
the liquid stream is fed to the separation membrane designed as the planar membrane and dead-end filtration is carried out for the liquid be treated.

5. The membrane separation process as claimed in claim 1, wherein a part of the irradiation element that couples out UV light is positioned in an immediate vicinity of the separation membrane or rests thereon.

6. The membrane separation process as claimed in claim 1, wherein the irradiation element of the membrane has a conduit into a pressure tube of a membrane module and optionally a conduit into an interior of the membrane module.

7. The membrane separation process as claimed in claim 1, wherein
the irradiation of the membrane via the irradiation element is effected in an intermittent, pulsed or continuous manner.

8. The membrane separation process as claimed in claim 1, wherein the irradiation is effected with constant irradiance or the irradiation is effected with varying irradiance.

9. The membrane separation process as claimed in claim 1, wherein the membrane separation process is a membrane separation process for treating drinking water, municipal wastewater, pre-treated municipal wastewater, industrial waters and/or saline waters.

10. The membrane separation process as claimed in claim 1, wherein the membrane separation process is a membrane separation process, a microfiltration process, an ultrafiltration process, a nanofiltration process, a forward osmosis process, a reverse osmosis process, a membrane distillation process, or an electrode ionization process.

11. A membrane module comprising a separation membrane,
wherein the separation membrane has an irradiation element at least on a side across which liquid to be treated is supplied thereto,
wherein
part of the irradiation element is formed as a woven fabric and/or noncrimp fabric and/or lattice and/or mesh composed of UV-light-radiating optical fibers or as a woven fabric, noncrimp fabric, lattice or mesh composed of UV-light-radiating optical fibers and non-UV-light-radiating plastic fibers.

12. The membrane module as claimed in claim 11, wherein the membrane module comprises a coupling device for connection of a light source.

13. The membrane module as claimed in claim 11, wherein the irradiation element comprises a light guiding element for low-loss transmission of UV light through a conduit into the membrane module.

14. The membrane module as claimed in claim 11, wherein the irradiation element is designed in such a way that reflection is effected for lateral out-coupling of the light radiation.

15. The membrane module as claimed in claim 11, wherein the membrane module is designed as a spiral-wound module.

16. The membrane module as claimed in claim 11, wherein the irradiation element is designed as part of a feed spacer or as a feed spacer.
